(19) United States
(12) Patent Application Publication
(10) Pub. No.: US 2004/0019549 A1
(43) Pub. Date: Jan. 29, 2004

(54) Method for estimating whether a stock is over-valued or under-valued

(76) Inventor: Jan Martin Gulbrandsen, Laguna Hills, CA (US)

Correspondence Address: LEONARD TACHNER, A PROFESSIONAL LAW CORPORATION, SUITE 38-E, 17961 SKY PARK CIRCLE, IRVINE, CA, 92614-6364, US

(21) Appl. No.: 10/205,802

(22) Filed: Jul. 26, 2002

(51) Int. Cl. G06F 17/60

(52) U.S. Cl. 705/36

(57) ABSTRACT

By analyzing the real-time order flow sent to electronic trading systems such as NASDAQ or individual ECNs and by analyzing the resulting price of the matched execution of buy and sell orders, very accurate lag-free indicators that show the true forces behind the normally considered random intraday price movements of the stock market can be created. These indicators, combined with the stock prices, show how overvalued or undervalued individual stocks or the whole market is compared to what the consensus price should be, based on the actual order flow. This enables traders to take advantage of intraday market price fluctuations of up to 2-4% and, up to hours in advance, to know when a current price move in the market is false and when it is very likely to reverse direction.

### BACKGROUND OF THE INVENTION

### Field of the Invention

The present invention relates generally to the field of stock market analysis and more specifically, to a method for determining whether stocks are under-valued or over-valued.

Traditional stock market analysis methods are based on statistical price pattern and volume analysis of the researched stocks. Because of the perceived erratic movements of the analyzed stocks, stock price trends and trend changes have been considered more or less random. This is commonly called “noise” in the trend of the stock price. The stock prices are noisy (a lot of random price movements around the actual underlying price direction) because hundreds of professional institutional and amateur day traders are trying to anticipate the current and future direction of the market. When guessing wrong they often panic and sell the stock again. This doubt, greed and fear cause these fluctuations in the stock prices as the trading day unfolds.

In order to be able to identify trends in the noisy stock price movement, past attempts have been made to somehow smooth the noisy data by using various data averaging techniques. The well-known problem with such techniques is that as the data is being made smoother a lag is also introduced in the smoothed data. The lag is approximately as big as the smoothing interval so when the smoothed signal becomes smoother it at the same time reacts slower to changes in the data being smoothed.

Professional and amateur day traders try to capitalize on intraday trends and trend changes of the stock market. They mainly use various indicators calculated from the traded stock's price and volume that are designed to help identify trends in the noisy data. As previously described, such indicators suffer from the noise and lag problems which cause such indicators to either give false indication of a price trend change (because the indicator interpreted noise as a price trend) or they give indication of a price direction trend change only after the trend change and price move is over (because the indicator is smoothed too much which makes it slow). This is the exact problem that causes short term investors and day traders to “buy at the top” (since the upwards trend look healthy and strong) and “sell at the bottom” (because once the indicators tell them that the trend has turned against them and they try to sell the stock it has already lost substantially in value).

There are literally hundreds of indicators in use today, some of which are explained in detail in Kaufman, Trading Systems and Methods Third edition, ISBN 0-471-14879-2. Most indicators are based upon one of three basic principles or a combination thereof:

Price smoothing using averaging methods. These indicators suffer from the false signal and the lag problem as previously described.

Oscillating indicators. These show how much the stock price has short-term moved compared to its immediate past but cannot accurately show how over or undervalued the price is nor do they show a meaningful trend. They are mainly used for timing an entry or exit in the timeframe of a few minutes since they only help the trader see the small picture.

Volume indicators. These try to find a relationship between trend changes in the stock price with changes in volume patterns. No such relationship has been proven to exist.

The conclusion is therefore that indicators based on price and volume are not effective for short-term trading.

It has been attempted numerous times in the past to use statistical methods to find some correlation between past price and volume trends, chart patterns and the future movements of the stock market. Well over hundred years of such research has not resulted in any accurate algorithms for predicting future market movements.

The stock market is a system like many other in nature. A system has some input, some transfer function (relation between input and output combined with some memory of previous state) and some output. The inputs to the electronic stock markets are the orders people place and the outputs are the actually executed orders and the resulting stock prices. Many attempts have been made to discover the transfer function of the market by using statistical methods. This is similar to trying to build an autopilot for an airplane that only uses statistical methods for determining the next course adjustment. Common sense says that this is bound to fail. There are simply too many unknown variables involved in controlling the airplane and statistical methods are not accurate enough. This will very likely result in an unstable system. Despite this, people are still trying to come up with exactly these kinds of statistical systems when trying to predict the stock market. The reason this has not been successful is that the available price and volume information doesn't contain enough information on which to base an accurate indicator. Any existing useful information in the stock price and volume is hidden by noise.

### SUMMARY OF THE INVENTION

By analyzing the real-time order flow sent to electronic trading systems such as NASDAQ or individual ECNs and by analyzing the resulting price of the matched execution of buy and sell orders, very accurate lag-free indicators that show the true forces behind the normally considered random intraday price movements of the stock market can be created. These indicators, combined with the stock prices, show how overvalued or undervalued individual stocks or the whole market is compared to what the consensus price should be, based on the actual order flow. This enables traders to take advantage of intraday market price fluctuations of up to 2-4% and, up to hours in advance, to know when a current price move in the market is false and when it is very likely to reverse direction.

A preferred embodiment of the inventive method hereof comprises the following steps:

a) determining the buy and sell order values placed on a selected stock by multiplying each order price by the corresponding order volume;

b) accumulating buy order value for a selected period for said stock,

c) accumulating buy order volume for said selected period for said stock;

d) dividing said accumulated buy order value by said accumulated buy order volume to establish a buy price channel line;

e) accumulating sell order value for said selected period for said selected stock;

f) accumulating sell order volume for said selected period for said selected stock;

g) dividing said accumulated sell order value by said accumulated sell order volume to establish a sell price channel line;

h) treating the difference between said buy price channel line and said sell price channel line as a price channel indicator for said stock; and

i) assessing said stock as over-valued if its actual price exceeds said sell price channel line, under-valued if its actual price is less than said buy price channel line and neither over-valued nor under-valued if its actual price is within said price channel indicator.

As used herein, the term “stock” is meant to apply to any form of publicly traded security or commodity for which there is a large market of potential buyers and sellers and at least one exchange or other entity which publishes order data for that security or commodity in substantially real time.

### BRIEF DESCRIPTION OF THE DRAWINGS

The aforementioned objects and advantages of the present invention, as well as additional objects and advantages thereof, will be more fully understood hereinafter as a result of a detailed description of a preferred embodiment when taken in conjunction with the following drawings in which:

FIG. 1 is an illustrative price channel chart showing how a stock price typically swings around the calculated price channel lines;

FIG. 2 is a chart showing how much, in percentage, the stock in FIG. 1 swings around the price channel lines;

FIG. 3 is a block diagram that illustrates how a system can be structured that retrieves order information from an electronic market, calculates the price channels and delivers the data to charts or to a custom consumer application; and

FIG. 4 is a block diagram of the inventive method illustrating program flow that calculates the accumulated order values necessary to produce the price channel lines and the over/undervalue lines as orders are received from the data source.

### DETAILED DESCRIPTION OF THE PREFERRED EMBODIMENT

Electronic Trading Systems.

Advances in modern computer communication and the performance increase of modern computers in the 1990's and 2000's allow us to take a modern approach to solving the over hundred-year-old problem with the perceived random movement of the stock market.

Nowadays, (year 2002) literally all stocks are traded in electronic trading systems such as NASDAQ and ECNs (Electronic Communications Networks). ECNs are part of NASDAQ and can be considered mini-markets within the whole market. These systems are high-speed databases that receive buy and sell orders from traders and institutions and that match these buy and sell orders when the price is right. Since the stock price for a specific security in one electronic stock trading system is synchronized with the rest of the market, a certain security's price in an ECN will be representative for that security elsewhere in the market. The largest ECN currently executes over 35% of certain stocks in NASDAQ. This means that the price and order information obtained from one part of the electronic trading market (such as from an ECN) will give an accurate picture of the whole market.

The Consensus Price of a Stock.

Because the prices of placed, canceled and executed orders change throughout a trading session as the market conditions and times change, we can calculate and visualize the consensus price that the market puts on a traded security. By treating the buy order information separate from the sell order information, we can calculate two sets of key consensus prices for a security which will change throughout the trading day:

1) The consensus sell price.

2) The consensus buy price.

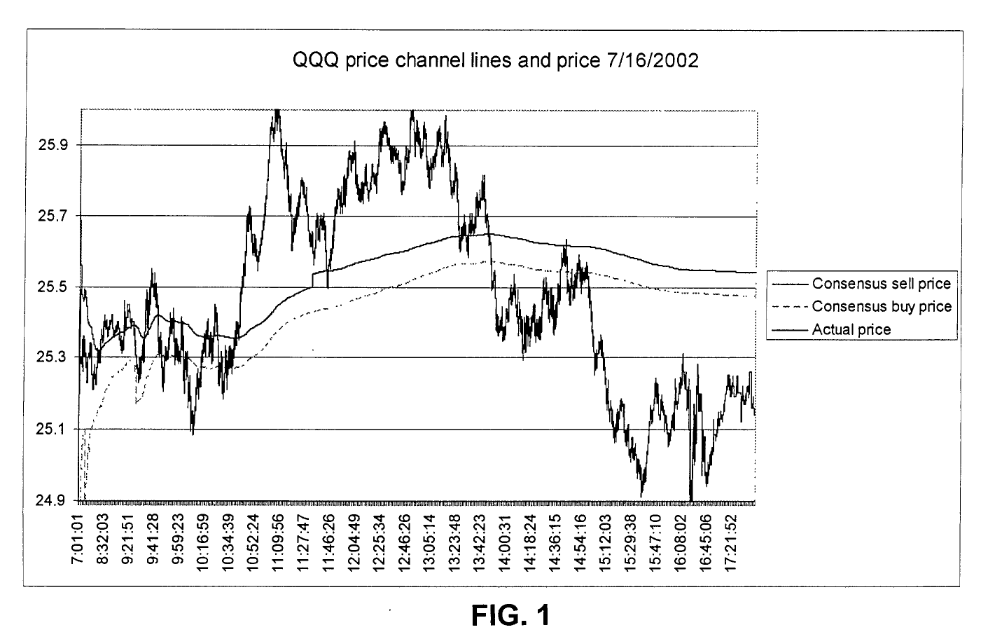

These two prices will move together as a pair as the trading day develops which will cause two price lines to develop as shown in FIG. 1. These price lines indicate the consensus buy and sell price that the market has on average set on a security at any given time throughout the trading day. The reason there are two lines is because of the “spread”, i.e., the difference between the price at which the sellers on average are willing to sell a stock and the price at which the buyers on average are willing to buy a stock. The area that is between the consensus buy and sell price lines is the area where on average the buyers and sellers agree (based on their placed orders) that is the fair value of the stock. The area between the price lines will hereinafter be called “the price channel”.

When a stock price is in the price channel (between the sell and buy price channel lines) the price will be referred to as “fairly valued”. If the stock price is over the price channel it will be referred to as “overvalued” and if the stock price is under the price channel it will be referred to as “undervalued”.

The Price Channel Line Definitions:

The methods for creating the price channel lines are as follows:

1) Sell price channel line value for stock XYZ=Accumulated intraday sell order value placed for stock XYZ/accumulated intraday sell order volume placed for stock XYZ.

2) Buy price channel line value for stock XYZ=Accumulated intraday buy order value placed for stock XYZ/accumulated intraday buy order volume placed for stock XYZ.

Where “order value placed”=order price*order volume for an order placed.

By dividing the accumulated intraday order value with the accumulated intraday order volume we get the “consensus” fair price of the stock. This is the price that collectively the whole market has set on the stock based on the orders placed. The reason this works is that the “accumulated value placed” divided with the “accumulated volume placed” results in the average price of the buy or sell orders placed (since value=price*volume=>value/volume=price). By using the accumulated value and volume as base for the calculations, we effectively eliminate the overshoot and undershoot of the stock price around the price channel because the over/undershoots are caused by a smaller subset of the active market participants and not the majority of the market participants (the majority of the market participants in effect create the price channel lines).

A large percentage of all placed orders are actually cancelled and not executed in some systems (over 70% of all placed orders are canceled in some ECNs). Because of this fact, the price channel calculation may work equally well when analyzing the cancelled order flow instead of the placed order flow because the price of the canceled orders are the same as of the placed orders. The placed order flow will however result in a somewhat more accurate result since the volume is higher.

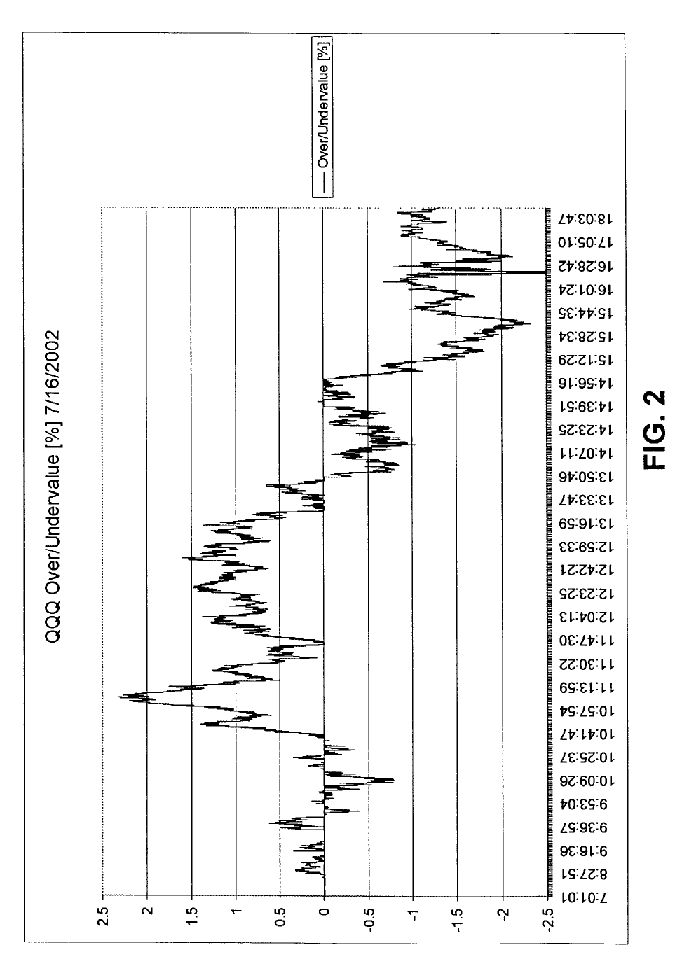

As can be seen in FIG. 1, the price swings around the price channel. When the price gets too overvalued it falls back down towards the price channel where it either gets support (as in the case around 11:40 in FIG. 1) or where it will continue down through the price channel as in the case around 13:30 in FIG. 1. FIG. 2 shows the over- and undervalue of FIG. 1 in percentage. It can be seen that QQQ this day reversed trend when becoming 2% over- and undervalued.

Support and Resistance.

The price channel lines show the true support and resistance in the actual order flow sent to the ECNs. The sell price channel line acts as a resistance on the stock price if it is moving up from being previously being undervalued and the buy price channel line acts as support if the stock price moves down after being overvalued. Note that when a stock price has been severely undervalued or overvalued and has reversed, the stock price is very likely to break through the support or resistance instead of reversing again when reaching the price channel, i.e., a new trend is very likely to continue until it overshoots in the new direction in which it is going. This can be seen in FIGS. 1 and 2.

Tracking Indices

A trader must look at the overall market conditions in addition to the monitored stocks and price channel indicators in order to profit from the over/under value. This is because any stock (under or overvalued) is likely to gain in value in a rising market and lose in value in a falling market. Hence the primary challenge is to determine what the market itself is doing. The secondary challenge is to select individual stocks to trade. By trading QQQ itself, the second challenge is eliminated.

By concurrently monitoring QQQ, DIA, SMH and SPY, an accurate picture can be obtained of the market as a whole. The reason for this is that all traders mainly monitor the NASDAQ, Dow Jones, S&P 500 and the SOX (Semiconductor index) to determine where the market is going. Since the exchange traded index tracking mutual funds QQQ, DIA, SMH and SPY move exactly like NASDAQ, Dow Jones, SOX (the semiconductor index) and the S&P 500, respectively we can get a very accurate picture of exactly how much, in percentage, the whole market is over and undervalued by monitoring these exchange traded funds. Other exchange-traded funds can be monitored if the trader has an interest in certain other sectors.

The Moves of the Market, the Oscillations Stock Prices, Overshoots etc.

No stock price travels on a straight line. It instead oscillates in waves in its target direction. These oscillations exist long term (ten year periods of up/down swings in the economy), more short term (monthly and weekly), intra day (morning to afternoon) and intra hour/minute. The reason that the market gets overheated (overshoots) is that people get overexcited which causes the stock price to climb to unsupported levels. Long term this causes peaks in the economy (as most recently at the end of the 90's) or downturns in the economy (beginning of the 1990's and 2000's). Medium term (month to month) it causes the stock price to oscillate some 10-20%. Short term this sometimes causes large intraday price fluctuations which will be detected by the price channel lines.

The Trend of the Price Channel Lines

The direction change of the price channel lines directly corresponds with the price direction. This is synonymous with the derivative (slope) of the price channel chart lines. Because the price channel lines are calculated from the accumulated placed order value and the accumulated placed order volume, a trend change of the placed value/placed volume ratio for a particular stock in any direction, will lead to a change in the direction of the price channels. For example a fall in the morning makes the stock price more and more undervalued. This corresponds to the price channel's second derivative becoming more and more negative (the same as saying that the trend of the price channel lines is going more and more down). When the trend of the price channel stops falling (its second derivative gets positive) and the market index or stock monitored becomes very undervalued in relation to the price channel, (order of −1% to −2% or more) it is a very accurate indication that the market will turn back up again. As always when doing trading, this should be confirmed by a change in the overall market conditions.

The price channel is a very accurate indicator but not a complete system. It helps determine when it's a good time to enter and exit the market, but the trader has to make the final decision when to enter and exit the market. Protective stops should always be used. If the market becomes further over/undervalued and the stop is executed, one simply tries again when the market has become even more under/over valued. It's not unusual to have to try to enter the market two or three times before accurately timing the bottom of a price fall. The price channel acts as a rubber band on the stock price that swings around it. The challenge is to determine how much force is in the market (how much the market can pull the “rubber band” from the price channel before the price is pulled back towards the price channel).

How to use the Price Channel Indicator

Because the indicator accurately shows how much over- or under valued is the market or an individual stock, it is used for timing the entry and exit of the market. When using a traditional indicator based on the current trend of the stock price and volume, traders enter the market when the market “looks strong”, i.e., when there is a strong trend in the market in the desired direction (upwards unless the trader is trying to short the traded stock, i.e., profit from a decline in the stock price). The problem with this approach is that when the market looks most strong, it is often most overvalued. Soon after as the trader enters the market (because the market looks strong) the market collapses and the trader wonders why this happened. The most likely reason is that the market was very overvalued (in relation to the price channel indicator) and performed a correction. A safer approach is to determine when the market is very undervalued and to buy at the bottom and sell at the top and not the other way around which is commonly done when using a normal price/volume based indicator. Because it cannot be determined if a stock is overvalued or undervalued by using a traditional price and volume based indicator, the price channel lines are very valuable tools for the trader.

The price channel indicator statistically shows that the NASDAQ is often around 1-3% overvalued before correcting back towards the price channel. Normal levels for under/over value before a correction occurs is for Dow Jones and S&P500=0.5-1% and for the SOX 2-5%. The SOX (the Philadelphia semiconductor index) most often leads the way in NASDAQ. If the SOX index is weak it's very hard for NASDAQ to rally. By using this knowledge, intra day price fluctuations of 1-3% or more can be traded upon.

Morning Market vs. Afternoon Market

An over or undervalued market in the first few hours of the trading day will most often correct back to the area of the price channel. The rules are different for the later hours of the market. An afternoon market tends to continue in the direction it is going in. If this direction is on the way back towards the price channel after a previously over or undervalued market, it is particularly safe to trade. This gives us four simple rules:

1) Never enter long in an overvalued market. The risk/reward ratio is too high. The price is much more prone to return back to the price channel than it is to continue going up.

2) Never enter short in an undervalued market. For the same reasons as in 1).

3) Never enter the market when the price is neither over- nor undervalued since you will be guessing the direction instead of relying on actual facts. The odds will be against you for the same reasons as in 1) and 2).

4) Never short an afternoon rally. Shorting afternoon rallies is particularly dangerous because such an overvalued market will not have time to fall back to the price channel before the market's closing.

Different Kinds of Market Movements and How to Trade Them

Since the prices of QQQ (NASDAQ), DIA (Dow Jones) and other indexes swing around their corresponding price channels, the trading day will develop based on how much power these index funds have to over- or under shoot around their price channels. Some examples:

1) Constantly down trending day: This day the market is constantly being forced down by the price channel lines. What this means is that the order pressure in the ECN is slowly pressing down the market. Since the market still is strong enough not to collapse there will be no over shoot downwards followed by an upwards recoil back towards the price channel.

2) Down day with collapse and upwards recoil back towards the price channel: The market got so undervalued that the stocks became worth buying which causes an upward market trend reversal. This is where the bulls take over from the bears. A very good time to go long.

3) Up day with a big overvalue followed by a collapse towards the price channel: This is the same principle as 2) above but enter short at the top.

4) Constantly up trending day: The price of QQQ, DIA etc will “bounce” on the price channel that has an upward trend. When the market goes a little too far it will fall back to the price channel where it gets support and then continues upward.

There can also be some combinations of these basic market trends. The key rules are to only trade on fact and not on guesses and enter long only in an undervalued market and go short only in an overvalued market.

An Example of How to Build a System that Performs the Price Channel Calculations.

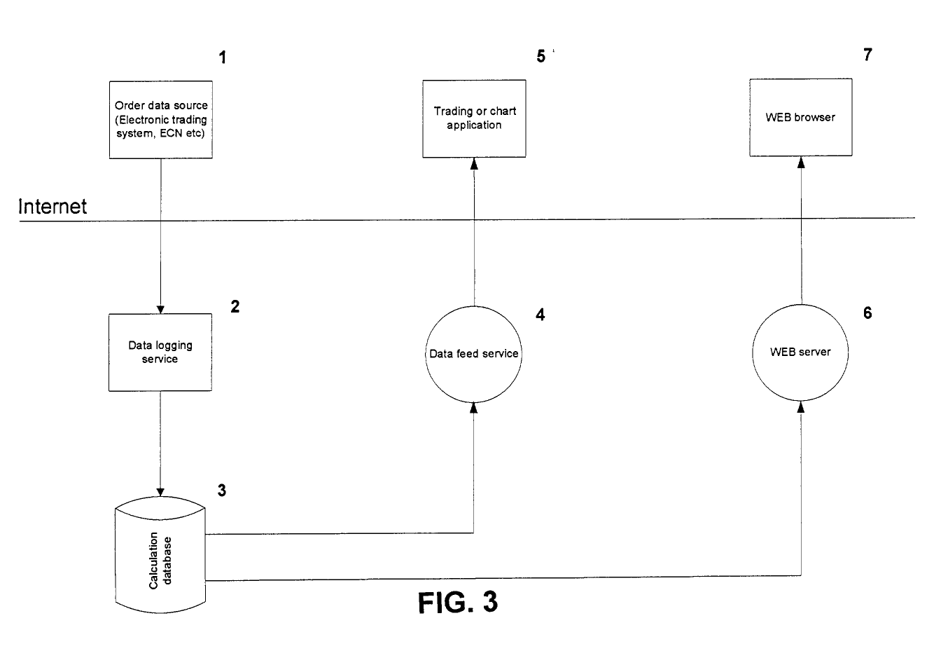

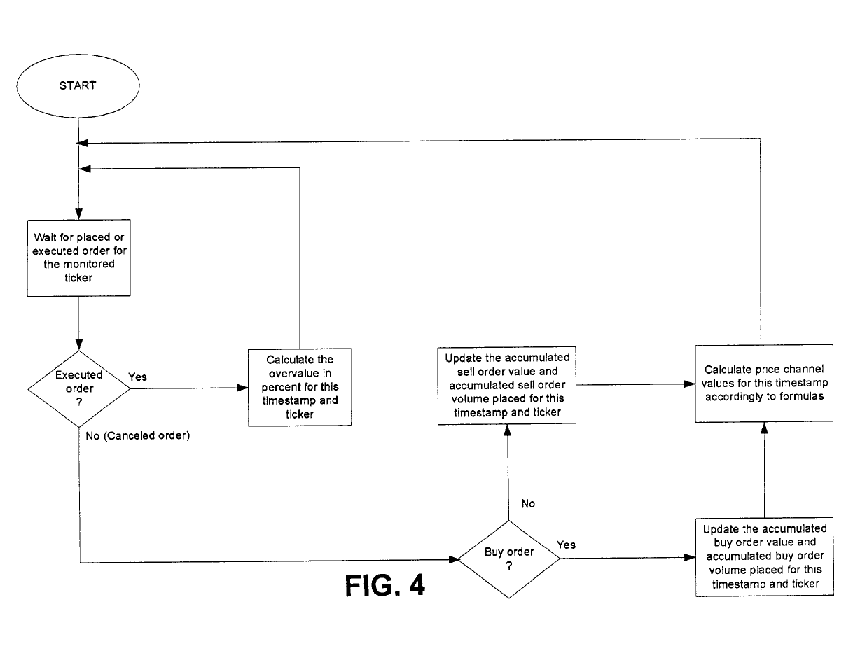

1) A service or daemon 2 of FIG. 3 connects to the data source 1 of FIG. 3 (NASDAQ, ECN or other electronic trading system that reveals the order flow of the monitored market) and calls a database, 3 of FIG. 3, for each order received. The database calculates the price channels in real-time as the data comes in; see FIG. 4.

2) The calculated price channel can be displayed in chart form on a client computer by running a desktop chart application directly on the client machine 5 of FIG. 3. The client application will then periodically connect to the data feed service, 4 of FIG. 3, and pull down new data that is needed to render the charts.

3) The price channel charts can also be displayed on WEB pages by preparing the image on the server 6 of FIG. 3 and sending it down to the client browser as an image embedded in an HTML page, 7 of FIG. 3.

4) Raw price channel data can also be directly distributed in raw form via the Internet or some other medium. This allows third party systems to directly obtain access to the price channel data feed, 4 of FIG. 3, that may be integrated into an in-house trading system.

Having thus disclosed a preferred embodiment of the inventive method hereof, it will be understood that various modifications and additions are readily perceived with the benefit of the illustrative teaching herein. Accordingly, the scope hereof is to be limited only by the appended claims and their equivalents.

I claim:

1. A method for determining whether the price of a stock is over-valued or under-valued; the method comprising the steps of:
a) determining the buy and sell order values placed on a selected stock by multiplying each order price by the corresponding order volume;
b) accumulating buy order value for a selected period for said stock;
c) accumulating buy order volume for said selected period for said stock;
d) dividing said accumulated buy order value by said accumulated buy order volume to, establish a buy price channel line;
e) accumulating sell order value for said selected period for said selected stock;
f) accumulating sell order volume for said selected period for said selected stock;
g) dividing said accumulated sell order value by said accumulated sell order volume to establish a sell price channel line;
h) treating the difference between said buy price channel line and said sell price channel line as a price channel indicator for said stock; and
i) accessing said stock as over-valued if its actual price exceeds said sell price channel line, under-valued if its actual price is less than said buy price channel line and neither over-valued nor under-valued if its actual price is within said price channel indicator.

2. The method recited in claim 1 wherein said order prices and order volumes are derived from an electronic trading system.

3. The method recited in claim 1 further comprising the step of updating said price channel indicator in real time as data for each new order for said stock is received.

4. The method recited in claim 1 further comprising the step of charting said price channel indicator over said selected period.

5. The method recited in claim 4 comprising the step of updating said charting as data for each new order for said stock is received.

6. The method recited in claim 4 further comprising the step of displaying said charting of said price channel indicator.

7. The method recited in claim 4 further comprising the steps of storing said charting as an image on a WEB server for access by a WEB browser.

8. The method recited in claim 1 further comprising the steps of storing said price channel indicator as an image on a WEB server for access by a WEB browser.

9. The method recited in claim 1 further comprising the steps of repeating steps a) through i) for an index of selected multiple securities for determining overall market trend; and
comparing the overall market trend with the determined under or over-value of said selected stock.

10. The method recited in claim 9 further comprising the step of charting respective price channel indicators for said selected stock and said index.

11. The method recited in claim 1 wherein said selected period is the entire period from that day's market opening until the most recent order for said stock.

12. A method for predicting the future price of a stock by estimating whether that stock is currently over-valued or under-valued; the method comprising the steps of:
a) receiving buy and sell order data for a selected stock over a selected period of time;
b) employing said order data to determine buy order value, buy order volume, sell order value and sell order volume of said stock accumulated over said period;
c) producing a buy price channel line based upon a ratio of accumulated buy order value to accumulated buy order volume;
d) producing a sell price channel line based upon a ratio of accumulated sell order value to accumulated sell order volume; and
e) comparing the current price of said stock to said buy price and sell price channel lines.

13. The method recited in claim 12 wherein said buy and sell order data are derived from an electronic trading system.

14. The method recited in claim 12 further comprising the step of updating said buy price and sell price channel lines in substantially real time as data for each new order for said stock is received.

15. The method recited in claim 12 further comprising the step of charting said buy price and sell price channel lines.

16. The method recited in claim 15 comprising the step of updating said charting as data for each new order for said stock is received.

17. The method recited in claim 15 further comprising the steps of storing said charting as an image on a WEB server for access by a WEB browser.

18. The method recited in claim 12 further comprising the steps of repeating steps a) through e) for an index of selected stocks for determining broader market trend; and
comparing the broader market trend with the estimated under or over-value of said stock.

19. The method recited in claim 12 wherein said selected period of time is the period between that day's market opening and the most recent order for said stock.
